(19) United States
(12) Patent Application Publication
(10) Pub. No.: US 2006/0065611 A1
(43) Pub. Date: Mar. 30, 2006

(54) System and method for storage and dispensing items

(76) Inventor: Frank Blateri, Coppell, TX (US)

Correspondence Address: HAYNES AND BOONE, LLP, 901 MAIN STREET, SUITE 3100, DALLAS, TX, 75202, US

(21) Appl. No.: 10/954,563

(22) Filed: Sep. 30, 2004

(51) Int. Cl. B42F 1/00; A47G 29/00

(52) U.S. Cl. 211/55; 211/85.15

(57) ABSTRACT

A system and method for storing items, such as food wrapping products, according to which two or more stacked modules are provided with each being adapted to store, and permit the dispensing of, a plurality of items.

### BACKGROUND

This invention relates to a system and method for storing and dispensing a plurality of items such as products for wrapping and/or storing food.

Products for wrapping and/or storing food are very common and include rolls of sheet material, such as foil, wax paper, plastic sheets, and the like, as well as bags made of various types of plastic and paper. These products are often sold in a package, or box, that has a slot or opening to permit the rolled sheet material, or the bags, to be removed from the box. However when these boxes are stacked in a cabinet or drawer for storage, it is difficult to pull the sheet material and the bags out from the storage boxes.

Therefore what is needed is a storage system for storing various items while enabling the items to be easily accessed, and the present invention addresses this need.

### BRIEF DESCRIPTION OF THE DRAWINGS

FIG. 1 is an isometric view of a storage system according to an embodiment of the invention, shown mounted to a support surface.

FIG. 2 is an enlarged view of the embodiment of FIG. 1 and depicting the materials being dispensed.

FIG. 3 is an exploded isometric view of a module of the embodiment of FIG. 1.

FIG. 4 is an enlarged partial isometric view showing a portion of the module of FIG. 3.

FIG. 5 is a side elevational view of the two modules of FIG. 1 shown in a spaced relationship.

FIG. 6 is a side elevational view of the modules of FIG. 5 shown connected.

### DETAILED DESCRIPTION

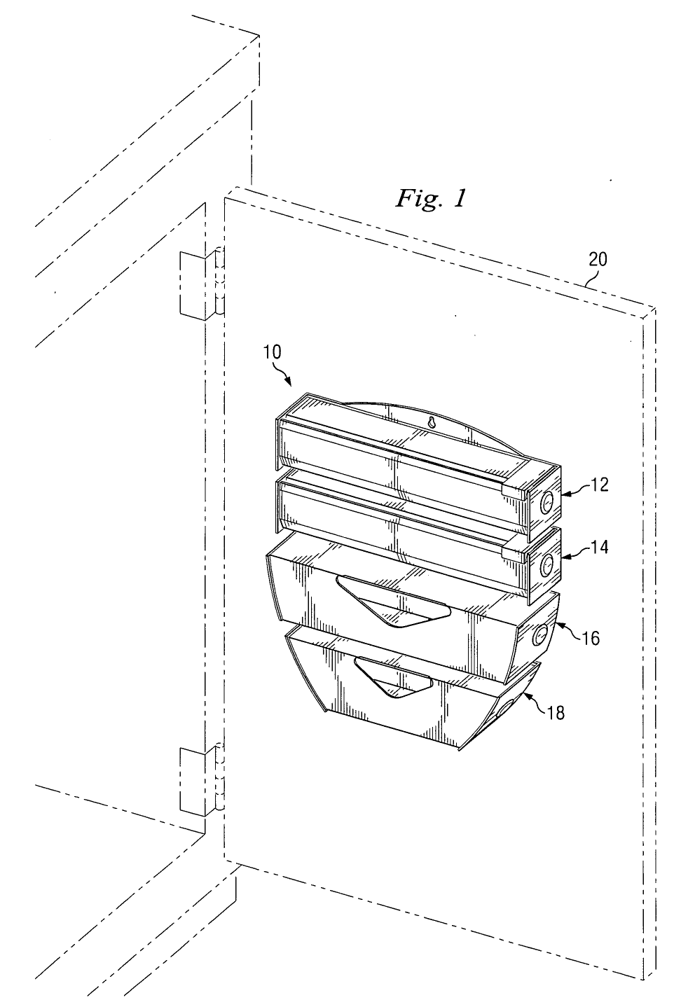

Referring to FIG. 1 of the drawing a storage system according to an embodiment of the invention is referred to, in general, by the reference numeral 10. The system consists of four storage modules 12, 14, 16, and 18 disposed in a stacked, or vertically-spaced, relation. It is understood that the system 10 can be affixed to the inner surface of a door 20 of a cabinet, pantry, or closet, in any conventional manner, such as by hooks, screws, hooks and loops, or any other type of fasteners.

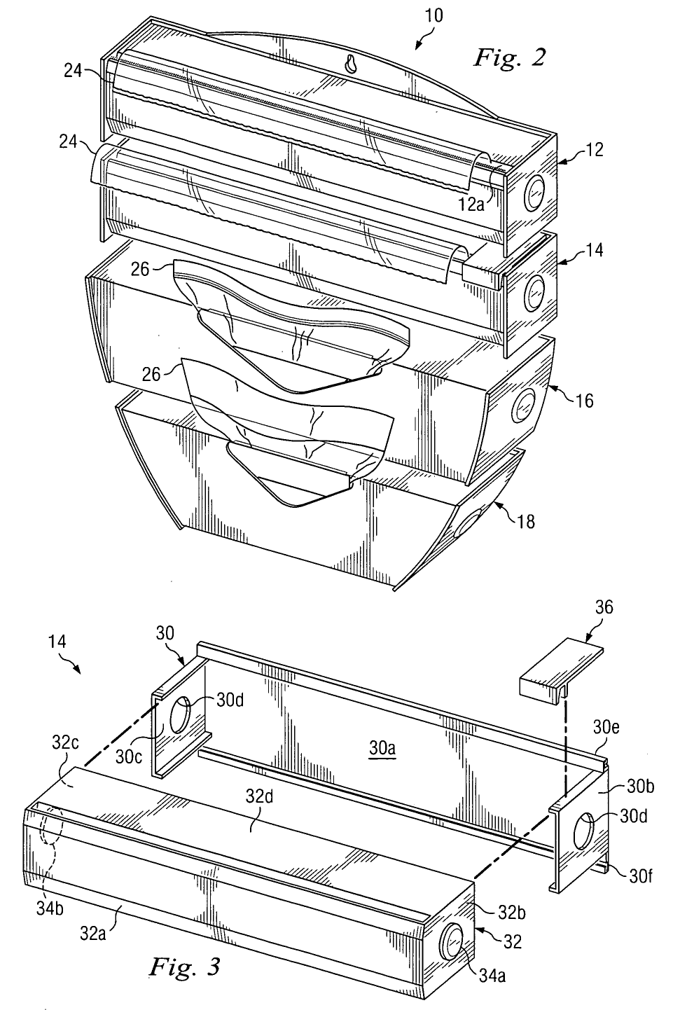

As shown in FIG. 2, the module 12 is designed to accommodate a roll of a sheet material, such as food wrapping material 24, which can be in the form of foil, paper, plastic, or the like. The material 24 can be one continuous rolled sheet, or a series of non-continuous rolled sheets, both of which are conventional and readily available in retail markets. The module 12 is generally rectangular in shape and defines an interior for receiving the roll of sheet material 24 which preferably is kept in its original box, or package, for reasons to be described. The leading end portion of the sheet material 24 is pulled from its original box, or package, and through an elongated slot 12a in the module 12 that extends for substantially the entire width of the module.

The module 14 extends just below the module 12 as viewed in FIGS. 1 and 2 and is connected to the module 12 in a manner to be described. With one exception to be discussed later, the module 14 is identical to the module 12 and therefore will not be described in detail. The module 14 is also adapted to dispense a roll of material 24.

The module 16 extends just below the module 14 and is connected to the module 14 in a manner to be described. The module 16 is designed to receive and dispense a series of stacked items, such as food storage bags 26. The module 16 is generally rectangular in shape with slightly tapered side walls to define an interior for receiving the bags 26. Preferably, the original box or package containing the bags can be placed in the module 16 and the bags dispensed from an opening in the latter box or package and through the module 16. To this end, a relatively large, triangularly-shaped, opening 16a is formed through the module 16 through which the bags 26 can be pulled.

The module 18 extends just below the module 16 as viewed in FIGS. 1 and 2 and is connected to the module 16 in a manner to be described. The module 18 is identical to the module 16 with the exception that it is slightly smaller than the module 16. The tapers of each side wall of the modules 16 and 18 are such that, when assembled, they form a continuous tapered surface. The module 18 is also adapted to dispense a series of storage bags 26.

Referring to FIG. 3, the module 12 consists of a mounting bracket 30 that rests against a support structure such as the door 20 (FIG. 1) and receives and supports a drawer, or housing 32. The mounting bracket 30 includes a back panel 30a and two side panels 30b and 30c extending from the back panel. A circular opening 30d is formed in each of the side panels 30b and 30c, and two connecting tabs 30e and 30f extend from the upper and lower edges, respectively, of the back panel 30a, for reasons to be described.

The housing 32 includes a front panel 32a, two side panels 32b and 32c, an upper panel 32d, and a lower panel (not shown). The slot 12a is formed in the top panel 32a of the housing 32. The width and height of the housing 32 are slightly less than the width and height, respectively, of the bracket 30 so that the housing 32 can fit in the bracket 30 to form an enclosure for storing the roll of sheet material 24. In this context, each side panel 30b and 30c of the bracket 30 has two flanges extending inwardly from its respective upper and lower edges, to receive the housing 32.

As a non-limiting example of a manner in which the housing 32 is locked to the bracket 30, two protruding members, in the form of circular knobs 34a and 34b are mounted on, and project outwardly from, the two side panels 32b and 32c, respectively, and are adapted to extend in the two openings 30d, respectively, in the bracket 30, as will be described in detail.

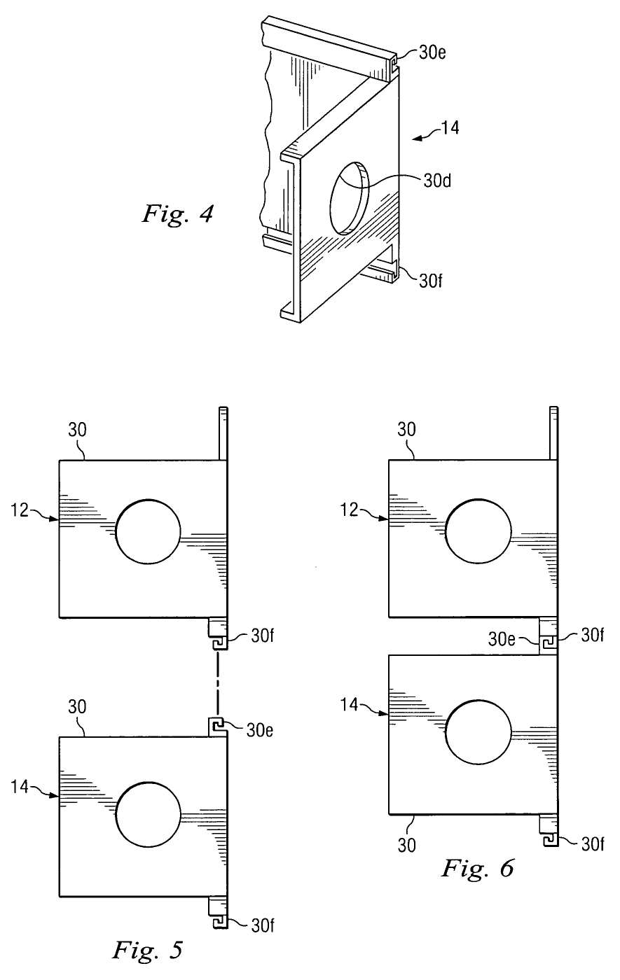

FIGS. 4-6 depict a non-limiting example of the manner in which the mounting brackets of the modules 12 and 14 can be connected. In particular the tab 30e extends from the upper edge of the back panel 30a of the bracket 30 of the module 14, and has a “J”, or hook-shaped cross section which is upside down as viewed in FIG. 5. Similarly, the tab 30f extends from the lower edge of the back panel 30a of the bracket 30 of the module 12 which also has a “J”, or hook-shaped cross section that is reversed with respect to the tab 30e. The tab 30f of the bracket 30 of the module 12 interlocks with the tab 30e of the bracket 30 of the module 14, as shown in FIG. 6, to connect the brackets 30 of each module 12 and 14.

A tab 30f is provided on the lower edge of the back panel of the bracket 30 of the module 14 which interlocks with a tab (not shown) on the module 16 that is identical to the tab 30e. Although not shown, it is understood that a tab identical to the tab 30f is provided on the lower edge of the back panel of the bracket 30 of the module 16 that interlocks with a tab identical to the tab 30e on the module 18. Thus, an unlimited number of modules can be stacked and connected in the above manner.

As shown in FIGS. 1 and 2, the upper module 12 does not have a tab with a “J”, or hook-shaped cross section, but rather has a curved tab that is not adapted to interlock, but rather is more attractive from an aesthetic standpoint. The latter tab is provided with an opening for receiving a fastener to fasten the system 10 to a support structure, such as the door 20 in FIG. 1.

Once the brackets 30 of the modules 12, 14, 16, 18, and 20 are connected in the above matter and fastened to a vertical support surface, such as the door 20 shown in FIG. 1, the roll of sheet material 24, contained in its original package, can be inserted into the interior of the housing 32 of the module 14 through the open rear thereof. The housing 32 is then aligned with the bracket 30, and, more particularly with the above mentioned flanges disposed on the side panels 30b and 30c of the bracket. The housing 32 can then be pushed towards the rear of the bracket 30, and, the latter panels can flex slightly outwardly to permit the knobs 34a and 34b to extend in the openings 32d, thus locking the housing 32 to the bracket 30. An enclosure is thus formed that contains the roll of sheet material 24. The leading end portion of the material 24 is passed through the slot 12a in the top panel 32c of the housing 32 to permit the material 24 to be dispensed from its original package and from the module 14. Assuming that the roll of material 24 is continuous and not precut, once the desired length of sheet material 24 is pulled from the module 12, the serrations of the original packing can be used to tear the material.

A roll of material, identical to the material 24, can also be inserted in, and dispensed from, the module 12 in the above manner, and a plurality of different items, such as the food storage bags 26, or the like, can be inserted in, and dispensed from the modules 16 and 18. In each case, the roll of sheet material 24 and the food storage bags 26 can be inserted in the housing of the particular module, and the housing can then be connected to its corresponding bracket in the manner described above.

As shown in FIG. 3, according to an alternate embodiment, the desired length of sheet material 24 can be cut from the roll of material using a cutting bracket 36 that includes two slightly-spaced, downwardly extending, flanges that receive a cutting blade, or the like (not shown). For the purpose of example, the bracket 36 is shown in connection with the module 14 in FIGS. 1-3 and would normally rest on the upper surface of the module. To cut the material 24, manual pressure can be applied to the bracket 36 in a downward direction, and the bracket then moved in a direction from right-to-left as viewed in FIGS. 1 and 2 so that the blade cuts the material 24. In this context, a sliding track (not shown) could be provided on the housing 32.

It is understood that a cutting bracket, identical to the cutting bracket 36, can be associated with the module 12.

The modules 12, 14, 16, and 18 can be fabricated of any material that is consistent with the uses described above. For example, each module 12, 14, 16, and 18 could be fabricated from a plastic material, or from a metal material. Also, the bracket 30 of each module could be fabricated from a plastic material and the housing 32 could be fabricated from a metal, or vice versa. In the event the buttons 34a and 34b and the openings 32d are used to connect each housing 32 to its corresponding bracket 30, at least one of the housing and bracket would be fabricated from a flexible material.

Variations may be made in the foregoing without departing from the scope of the invention. Examples of the variations are as follows:

(1) The housing 32 can be locked to the bracket 30 in a manner other than by the knobs 34a and 34b, such as by locking screws, pins buttons, tabs, etc.

(2) The adjacent modules can be connected together in a manner other than by the tabs 30e and 30f, such as by screws or any other interlocking techniques.

(3) The number of modules 10 can be varied

(4) The roll of sheet material 24 or the bags 26 can be removed from their original boxes, or packages, prior to being placed in the modules 12, 14 and 16, 18, respectively. In the former case, the cutting bracket 36 can be used, or one surface of the module 12 defining the slot 12a can be serrated for permitting the sheet material 24 to be cut, or the cutting bracket 36 can be used.

(5) Only one knob 34a or 34b can be provided.

(6) The knobs 34a and 34b can be provided on the bracket and the openings for receiving the knobs can be provided on the housing.

(7) The number and configuration of the panels making up the bracket 30 and the housing 32 can be varied.

(8) Spatial references, such as “upper”, “lower”, “top”, “bottom”, “side”, etc. are for the purpose of illustration only and do not limit the specific orientation or location of the elements described above.

(9) The above embodiments are not limited to storing sheet material and food storage bags, but rather can be used to store other items.

Although only a few exemplary embodiments of this invention have been described in detail above, those skilled in the art will readily appreciate that many other modifications are possible in the exemplary embodiments without materially departing from the novel teachings and advantages of this invention. Accordingly, all such modifications are intended to be included within the scope of this invention as defined in the following claims. In the claims, means-plus-function clauses are intended to cover the structures described herein as performing the recited function and not only structural equivalents, but also equivalent structures.

What is claimed is:

1. A system for storing a plurality of items, the system comprising at least one module for receiving at least one item, the module comprising a bracket, and a housing supported by the bracket for and forming, with the bracket, an enclosure for storing the items and permitting dispensing of the items.

2. The system of claim 1 further comprising means for locking the housing to the bracket.

3. The system of claim 2 wherein the bracket comprises two side panels at least one of which has an opening formed therein, and wherein the housing comprises two side panels that extend within, and adjacent to, the side panels of the bracket.

4. The system of claim 3 wherein the locking means comprises a protruding member disposed on at least one side panel and adapted to extend in an opening formed in its adjacent side panel.

5. The system of claim 3 wherein a protruding member is disposed on each side panel of the housing and wherein an opening is formed through each side panel of the bracket for receiving a corresponding protruding member.

6. The system of claim 5 wherein the bracket is formed of a material that flexes so as to permit the protruding members to extend through the corresponding openings.

7. The system of claim 1 wherein there are at least two modules that are adapted to be disposed in a stacked relationship with the respective brackets of the modules being connected.

8. The system of claim 7 further comprising an interlocking tab provided on the bracket of each module, the tabs of adjacent modules interlocking to connect the latter modules.

9. The system of claim 8 wherein one of the modules extends above the other module, wherein the tab of the one module extends from a lower surface of its bracket, and wherein the tab of the other module extends from an upper surface of its bracket.

10. The system of claim 9 wherein the tabs have a substantially hooked shaped cross section that engage to interlock.

11. The system of claim 1 wherein the housing of at least one module is adapted to dispense a roll of sheet material.

12. The system of claim 11 wherein an elongated slot is formed through the housing of the latter module to permit the sheet material to be dispensed from the module.

13. The system of claim 12 wherein the sheet material is continuous and wherein a portion of the first module defining the slot is serrated to cut the sheet material.

14. The system of claim 12 wherein the sheet material is continuous and further comprising a bracket adapted to slide across the housing to cut the sheet material.

15. The system of claim 11 wherein the housing of at least one other module receives a series of stacked bags and has a opening for providing access to the bags.

16. The system of claim 1 wherein the housing of at least one module receives a series of stacked bags and has a opening for providing access to the bags.

17. The system of claim 1 wherein at least one module is adapted to be connected to a vertical support surface.

18. The system of claim 1 wherein the items are food wrapping and/or storage products.

19. The system of claim 18 wherein the items are selected from a group consisting of a roll of sheet material and a plurality of storage bags.

20. A method of assembling a system for storing a plurality of items, the method comprising connecting a first bracket to a second bracket, disposing items in a first housing, connecting the first housing to the first bracket to form an enclosure for storing some of the items and allowing the items to be dispensed, and connecting the second housing to the second bracket to form an enclosure for storing some of the items and allowing the latter items to be dispensed.

21. The method of claim 20 further comprising connecting a third bracket to the first bracket, disposing items in a third housing, connecting the third housing to the third bracket to form an enclosure for storing the last items and allowing the last items to be dispensed.

22. The method of claim 20 wherein the items are food wrapping and/or storage products.

23. The method of claim 20 wherein the items are selected from a group consisting of a roll of sheet material and a plurality of storage bags.
